(19) United States
(12) Patent Application Publication
(10) Pub. No.: US 2008/0084154 A1
(43) Pub. Date: Apr. 10, 2008

(54) PLASMA DISPLAY PANEL AND METHOD OF MANUFACTURING THE SAME

(76) Inventors: Byoung-Min Chun, Suwon-si (KR); Won-Ju Yi, Suwon-si (KR); Kyoung-Doo Kang, Suwon-si (KR); Yong-Shik Hwang, Suwon-si (KR); Tae-Seung Cho, Suwon-si (KR); Jong-Woo Choi, Suwon-si (KR); Seok-Gyun Woo, Suwon-si (KR); Jae-Ik Kwon, Suwon-si (KR); Young-Do Choi, Suwon-si (KR)

Correspondence Address: CHRISTIE, PARKER & HALE, LLP, PO BOX 7068, PASADENA, CA, 91109-7068, US

(21) Appl. No.: 11/843,872

(22) Filed: Aug. 23, 2007

(30) Foreign Application Priority Data
Oct. 9, 2006 (KR) 10-2006-0098144

(51) Int. Cl. G09F 9/313; H01J 17/49

(52) U.S. Cl. 313/491; 313/584; 313/585

(57) ABSTRACT

A plasma display panel and a method of manufacturing the same is provided. The plasma display panel includes a front substrate and a rear substrate spaced apart from each other. A plurality of electrode sheets are stacked between the front substrate and the rear substrate, and have apertures for forming a plurality of discharge spaces. The electrode sheets include a plurality of metal discharge electrodes extending so as to surround at least a part of each of the discharge spaces arranged in a column, and are separated from each other. Insulation members are located between the metal discharge electrodes, are formed of a oxide material of the metal of the metal discharge electrodes and insulate the metal discharge electrodes.

### CROSS-REFERENCE TO RELATED PATENT APPLICATION

This application claims priority to and the benefit of Korean Patent Application No. 10-2006-0098144, filed on Oct. 9, 2006, in the Korean Intellectual Property Office, the entire content of which is incorporated herein by reference.

### BACKGROUND OF THE INVENTION

1. Field of the Invention

The present invention relates to a plasma display panel (PDP), and more particularly, to a PDP having high luminous efficiency and an improved structure adapted for mass production, and a method of manufacturing the same.

2. Description of the Related Art

Plasma display devices using PDPs are flat display devices. Plasma display devices are considered to be the next-generation of large flat display devices owing to their positive characteristics, such as high quality, slim structure, light weight, wide viewing angles, and easier manufacturing method and larger screen size compared to those of other flat display devices.

Generally, PDPs can be classified into a direct current (DC) PDP, an alternating current (AC) PDP, and a hybrid PDP according to their type of driving voltage. PDPs can be classified into an opposed discharge PDP and a surface discharge PDP according to their discharge structure. Those PDPs which are produced worldwide are mainly three-electrode surface discharge PDPs.

Since three-electrode surface discharge PDPs may have a deterioration of phosphors, reduction of transmittance of visible light, reduction of luminous efficiency, and the like, research into PDPs having a new structure is currently being undertaken.

FIG. 1 is a partially exploded perspective view of a PDP disclosed in Korean Patent Laid-Open Publication No. 2005-0104003. The PDP includes a front substrate 10 and a rear substrate 20, which are spaced a predetermined distance apart and face each other. A plurality of front barrier ribs 31 and rear barrier ribs 24 are disposed perpendicular to each other and are located between the front substrate 10 and the rear substrate 20 so as to partition discharge spaces S. A plurality of first discharge electrodes 35 and second discharge electrodes 45, which are spaced apart above and below from each other, are buried in the front barrier ribs 31 in order to generate a display discharge in the discharge spaces S. The front barrier ribs 31 bury the first discharge electrodes 35 and second discharge electrodes 45 in order to prevent the first discharge electrodes 35 and second discharge electrodes 45 from being damaged due to ion shock and to provide a favorable environment for the display discharge, and are formed of a dielectric substance. Phosphor layers 25 are disposed in areas partitioned by the rear barrier ribs 24. A plurality of address electrodes 22, extending so as to cross the discharge spaces S, are disposed on the rear substrate 20. A dielectric layer 21 for burying the address electrodes 22 is disposed between the rear substrate 20 and the rear barrier ribs 24.

In the PDP, since the discharge is generated through side walls partitioning the discharge spaces S, the phosphor layers 25 disposed on the rear substrate 20 rarely deteriorate due to the ion shock. An opaque electrode element is excluded from the front substrate 10 and thus transmittance of visible light is increased. The discharge is generated through all the side walls of the discharge spaces S. Plasma can be focused on the center of each of the discharge spaces S, thereby dramatically increasing ultraviolet rays.

However, the above-described PDP cannot be easily mass produced using conventional manufacturing methods since the first discharge electrodes 35 and second discharge electrodes 45 are buried in the front barrier ribs 31. As such, this type PDP is not typically used because of its manufacturing problems.

### SUMMARY OF THE INVENTION

In accordance with the present invention a PDP having high luminous efficiency and an improved structure adapted for mass production, and its method of manufacture, is provided.

According to an aspect of the present invention, a PDP includes a front substrate and a rear substrate spaced apart from each other. A plurality of electrode sheets are stacked between the front substrate and the rear substrate, and have apertures for forming a plurality of discharge spaces. The electrode sheets include a plurality of discharge electrodes extending so as to surround at least a part of each of the discharge spaces arranged in a line, and are separated from each other. Insulation members are located between the discharge electrodes, and are formed of the oxide material of the same metal as the discharge electrodes in order to support and insulate the discharge electrodes.

According to another aspect of the present invention, a PDP includes a front substrate and a rear substrate spaced apart from each other. A first electrode sheet and a second electrode sheet are stacked between the front substrate and the rear substrate, and have apertures for forming a plurality of discharge spaces. The first electrode sheet includes a plurality of first discharge electrodes extending so as to surround at least a part of each of the discharge spaces arranged in a first direction, and are separated from each other. An insulation layer is integrally formed with the first discharge electrodes so as to have a vertical step therebetween, and is formed of the oxide material of the same metal as the first discharge electrodes in order to support and insulate the first discharge electrodes. The second electrode sheet includes a plurality of second discharge electrodes extending so as to surround at least a part of each of the discharge spaces arranged in a second direction, and are separated from each other. An insulation layer is integrally formed with the second discharge electrodes so as to have a vertical step therebetween, and is formed of the oxide material of the same metal as the second discharge electrodes in order to support and insulate the second discharge electrodes.

According to another aspect of the present invention, a PDP includes a front substrate and a rear substrate spaced apart from each other. A first electrode sheet and a second electrode sheet are stacked between the front substrate and the rear substrate, and have apertures for forming a plurality of discharge spaces. The first electrode sheet includes a plurality of first discharge electrodes having discharge portions surrounding the discharge spaces arranged in a line and electrical connection portions electrically connecting the discharge portions; and one or more bridges integrally formed with the adjacent first discharge electrodes and extending so as to have a narrower width than the electrical connection portions in order to support and insulate the first discharge electrodes. The second electrode sheet includes a plurality of second discharge electrodes having discharge portions surrounding the discharge spaces arranged in a line and electrical connection portions electrically connecting the discharge portions; and one or more bridges integrally formed with the adjacent second discharge electrodes and extending so as to have a narrower width than the electrical connection portions in order to support and insulate the second discharge electrodes.

According to another aspect of the present invention, a method of manufacturing a PDP having a plurality of discharge spaces disposed in an array and a plurality of discharge electrodes extending so as to surround the discharge spaces and be separated from each other, is provided. A raw material of a metal sheet is prepared. A first photoresist (PR) mask is formed covering the discharge electrodes on one side of the metal sheet. A second PR mask is formed covering the discharge electrodes on the other side of the metal sheet. One side of the metal sheet exposed through the first PR mask is selectively first etched. The other side of the metal sheet exposed through the second PR mask is selectively second etched. The first PR mask and the second PR mask are peeled off the metal sheet. The metal sheet is anodized in order to insulate the outer surfaces of the discharge electrodes and areas between the discharge electrodes. Two or more metal sheets are prepared by repeating the above operations. The metal sheets are layered to face each other. The metal sheets are perpendicularly aligned. A front substrate and a rear substrate are combined so as to face each other using a frit sealing agent with the metal sheets disposed therebetween.

### BRIEF DESCRIPTION OF THE DRAWINGS

FIG. 1 is a partially exploded perspective view of a conventional PDP.

FIG. 2 is an exploded perspective view of a PDP according to an embodiment of the present invention.

FIG. 3A is a partial cross-sectional view taken along lines III-III of FIG. 2.

FIG. 3B is a partial cross-sectional view taken along lines III′-III′ of FIG. 2.

FIG. 4 is an enlarged perspective view of the discharge electrodes illustrated in FIG. 2.

FIG. 5 is a plan view of a modified structure of the electrode sheet illustrated in FIG. 2.

FIG. 6A is a partial cross-sectional view of a PDP according to the modified example illustrated in FIG. 3A.

FIG. 6B is a partial cross-sectional view according to the modified example illustrated in FIG. 3B.

FIGS. 7A through 7H are partial cross-sectional views illustrating a method of manufacturing electrode sheets according to an embodiment of the present invention.

FIG. 8 is an exploded perspective view of a PDP according to another embodiment of the present invention.

FIG. 9A is a partial cross-sectional view taken along a line IX-IX denoted in FIG. 8.

FIG. 9B is a partial cross-sectional view taken along a line IX′-IX′ denoted in FIG. 8.

FIG. 10 is an enlarged perspective view of a part of the electrode sheets illustrated in FIG. 8.

FIG. 11 is a plan view of the electrode sheets illustrated in FIG. 8.

### DETAILED DESCRIPTION

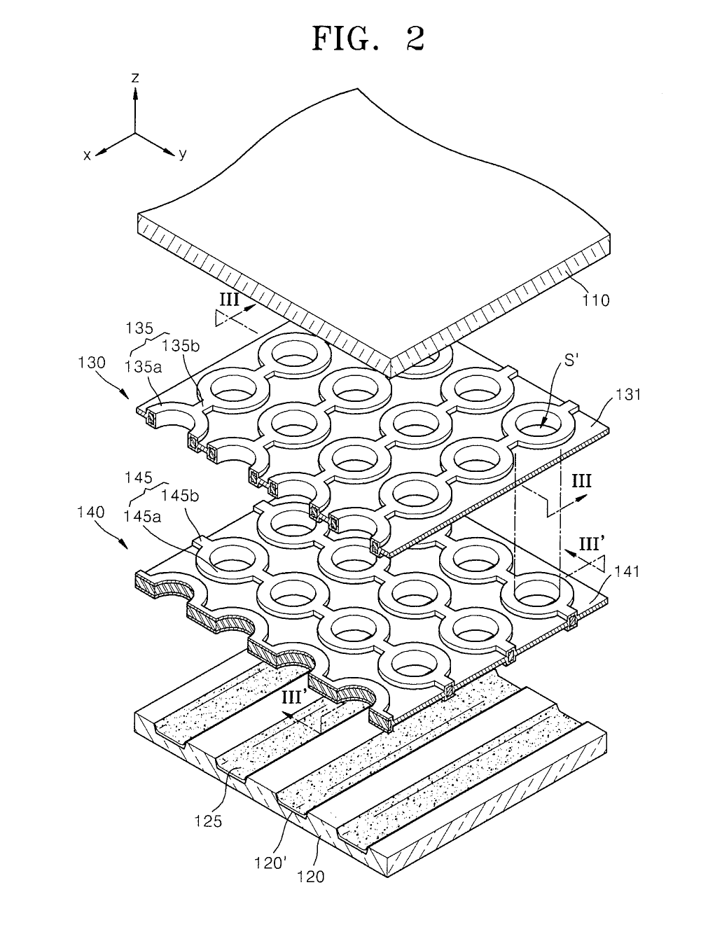

Referring now to FIGS. 2, 3A, 3B and 4, the PDP includes a front substrate 110 and a rear substrate 120, which are separated from each other by a predetermined gap. A first electrode sheet 130 and a second electrode sheet 140, are interposed facing each other between the substrates 110, 120, and form a plurality of discharge spaces S′. The front substrate 110 becomes an image display surface on which a predetermined image is realized. To this end, the front substrate 110 may be a glass substrate made of glass having excellent light transmittance.

The respective first electrode sheet 130 and the second electrode sheet 140, which have an integrated structure, are formed by forming discharge electrodes 135, 145 with a predetermined pattern in a raw material metal sheet, and insulating a portion of the metal sheet through oxidation. Hereinafter, the structure of the first electrode sheet 130 and the second electrode sheet 140 will be described in greater detail.

A plurality of discharge spaces S′ are formed in the first electrode sheet 130 and are arranged in a matrix pattern. Here, the discharge spaces S′ mean spaces in which a predetermined electric field for causing a display discharge is formed and a discharge gas that can be excited as a result of the discharge is filled. In an embodiment of the present invention, the first electrode sheet 130 and the second electrode sheet 140 face each other in a vertical direction and together form the discharge spaces S′. Thus, an upper space and a lower space respectively formed in the first and second electrode sheets 130, 140 become respective portions of the discharge spaces S′. Throughout the present specification, for convenience of description, the upper or lower space formed in each of the sheets 130, 140 are each referred to as the discharge spaces S′. However, in a strict sense, the space formed in each of the sheets 130, 140 constructs a portion of the discharge spaces S′.

As circular opening patterns are formed in the first and second electrode sheets 130, 140, each of the discharge spaces S′ has a cylindrical shape. Alternatively to the circular opening pattern, as polygonal opening patterns may be formed in each of the electrode sheets 130, 140, each of the discharge spaces S′ could then be formed in polyhedral structures, such as a hexahedral structure. Each of the discharge spaces S′ may also be formed in any structure in which a discharge gas is filled, and is not limited to a specific shape.

The first electrode sheet 130 includes a plurality of first discharge electrodes 135 which surround the discharge spaces S′ arranged in a line and extend in one direction (an x direction). Each of the first discharge electrodes 135 includes a discharge portion 135a surrounding the discharge spaces S′ and generating a discharge, and an electrical connection portion 135b for electrically connecting the discharge portions 135a and supplying driving power to adjacent discharge portions 135a. Since the discharge portion 135a defines the discharge spaces S′ as a corresponding shape according to the shape of the discharge portion 135a, the shape of the discharge portion 135a may be appropriately changed, so as to form the discharge spaces S′ having various shapes according to specific embodiments.

The first discharge electrode 135 illustrated in FIGS. 2, 3A, 3B, and 4 completely surround sides of the discharge spaces S′. For example, in order to restrict a discharge current, the first discharge electrode 135 may surround only a portion of the discharge spaces S′. In this case, the discharge electrode 135 may have a shape in which its portion is opened. The opened portion may be formed of an insulating layer 131 for forming a vertical step difference with the discharge electrode 135, like other regions of the electrode sheet 130 besides the discharge electrode 135.

When a driving voltage is applied to the discharge electrode 135 through one end connected to an external power source, a predetermined electric field for discharge firing would be formed within the discharge spaces S′ surrounded by the discharge portion 135a. The discharge electrode 135 may be formed of a metallic material having excellent electrical conductivity, for example, aluminium, so as to minimize a dissipation loss caused by resistance.

An oxide film 135t is formed on an outer surface of the first discharge electrode 135 to a predetermined thickness Tₒ by oxide processing such as anodizing. A large portion of the discharge electrode 135 surrounded by the oxide film 135t remains as a core portion 135c, which is not oxidized and maintains electrically conductive. The first discharge electrode 135 may be electrically insulated by the oxide film 135t from an external environment. For example, the oxide film 135t may be formed of insulating alumina (Al₂O₃) when aluminium (Al) is used in forming the discharge electrode. The oxide film 135 formed on the surface in contact with the discharge spaces S′ functions as a protective layer for preventing electrode damage caused by collisions with charged particles participating in a discharge, and serves as a conventional dielectric layer for burying a discharge electrode and establishing advantageous conditions for discharge to occur. The oxide film 135t for protecting the discharge electrodes 135 may be formed to a sufficient thickness taking into consideration withstand voltage characteristics. The thickness Tₒ of the oxide film 135t may be optimized by controlling process conditions such as applied current, selection of electrolytic solution, and process time when an oxidation process is performed. The surface of the first discharge electrode 135 is coated with the oxide film 135t in order to prevent an electrical short circuit with the second discharge electrode 145 disposed below the first discharge electrode 135.

The insulating layer 131 is formed between the first discharge electrodes 135 so as to form a unitary body therewith. The first discharge electrodes 135 support each other by means of the insulating layer 131, and bending deformation or the like of the electrode sheet 130 may be prevented so that handling during a production process can be more convenient. As illustrated, the insulating layer 131 constitutes all regions of the electrode sheet 130 excluding the discharge electrode 135. Due to characteristics of an anodizing process in which oxidation is performed on a surface, an opening may be formed in a portion of the insulating layer 131, so as to promote oxidation processing. In this case, oxidation may also be performed on an opened and exposed surface.

The insulating layer 131 supports the first discharge electrodes 135 and electrically insulates the first discharge electrodes 135 from one another. To this end, the insulating layer 131 is formed of an electrical insulating layer and may be formed of a metallic oxide, which is obtained by performing an oxidation process on the same metallic material as the material used in forming the first discharge electrode 135. For example, when a portion corresponding to the insulating layer 131 is insulated by anodizing an aluminium sheet in which electrode patterns are formed, the insulating layer 131 may be formed of alumina (Al₂O₃) which is an oxide of aluminium (Al).

The insulating layer 131 is formed to a relatively small thickness Tᵢ while forming a vertical step difference with the first discharge electrode 135. For example, the insulating layer 131 may be formed to a small thickness T₁ while forming step differences d₁, d₂ with the first discharge electrode 135 in a vertical direction. The thickness Tᵢ of the insulating layer 131 may be established according to specific process conditions of anodizing. While oxidation is performed from the surface of the insulating layer 131 to its inside through anodizing, the insulating layer 131 may be formed to such a small thickness that the portion corresponding to the insulating layer 131 is completely oxidized. When the thickness Ti of the insulating layer 131 is formed to a larger thickness, the inside of the insulating layer 131 is not oxidized but maintains electrically conductive. Thus, insulation layer 131 would short circuit first discharge electrodes 135. Therefore, the insulating layer 131 needs to be formed to a sufficiently small thickness including a process margin. In order to form the first discharge electrode 135 and the insulating layer 131 having different thicknesses, both sides of the insulating layer 131 portion are etched in an aluminium sheet which is a raw material so that a double-sided step structure with the first discharge electrode 135 is formed. In this case, when the step differences d₁, d₂, between the insulating layer 131 and the discharge electrode 135 are equally designed on one side and the other side of the insulating layer 131, double-side etching may be symmetrically performed, and neither side of the insulating layer 131 needs to be discriminated from each other, thus making manufacturing more straightforward.

The vertical step differences d₁, d₂ between the discharge electrode 135 and the insulating layer 131 are designed to have different thicknesses so that the first discharge electrode 135 exposed to the same oxidation conditions maintains conductivity and the insulating layer 131 is completely insulated all the way through. However, a step space g incidentally formed in upper and lower portions of the insulating layer 131 may be provided as an outlet and an inlet for gases such as an impurity gas and a discharge gas in which the impurity gas within a discharge space S′ is exhausted and the discharge gas is filled. As such, an exhaustion-sealing processing time can be reduced, and the high purity of the discharge gas can be maintained without a residual impurity gas remaining in the discharge spaces S′ so that the step space g contributes to discharge stability.

The second electrode sheet 140 that faces the first electrode sheet 130 is disposed on a lower side of the first electrode sheet 130. The second electrode sheet 140 may be formed so as to be similar to the above-described first electrode sheet 130. More specifically, a plurality of discharge spaces S′ are formed in the second electrode sheet 140 in a predetermined arrangement. A plurality of second discharge electrodes 145 are formed to surround the discharge spaces S′ and to extend in one direction. Each of the second discharge electrodes 145 includes a discharge portion 145a surrounding the discharge spaces S′ and an electrical connection portion 145b electrically connecting the discharge portions 145a. The second discharge electrodes 145 may extend in a y direction that crosses the first discharge electrodes 135 extending in an x direction. This is because, in passive matrix (PM) addressing, one discharge electrode serves as an address electrode and the other discharge electrode serves as a scan electrode so that a selection operation of a discharge space in which a display discharge will occur, can be performed. For example, the first discharge electrode 135 may be driven as a scan electrode, and the second discharge electrode 145 may be driven as an address electrode. The technical scope of the present invention is not limited by the above-described electrode structure, and the technical spirit of the present invention may also be applied to an electrode structure including additional address electrodes which are arranged so that the first and second discharge electrodes 135, 145 extend parallel to each other, and which extend in a direction that crosses the discharge electrodes 135, 145. In this case, one discharge electrode of the discharge electrodes 135, 145 serves as a scan electrode and may cause an address discharge for selection of a discharge space together with an address electrode.

The second discharge electrodes 145 are supported and insulated by an insulating layer 141 for forming a region therebetween, and the insulating layer 141 is formed to a small thickness Tᵢ′ while forming step differences d₁′, d₂′ with the second discharge electrodes 145. More specifically, the insulating layer 141 may be formed to a thin film thickness Tᵢ′ while forming the step differences d₁′, d₂′ in both directions from upper and lower ends of the second discharge electrode 145. The first and second electrode sheets 130, 140 may be combined to face each other by a nonconductive dielectric adhesive layer 165 interposed between the first and second electrode sheets 130, 140.

The rear substrate 120 that faces the front substrate 110 may be a glass substrate mainly formed of glass, like the front substrate 110. A plurality of grooves 120′ are formed at positions corresponding to the discharge spaces S′ on an inner surface of the rear substrate 120, and phosphor layers 125 are disposed in the inner surface of the rear substrate 120 along the grooves 120′. The grooves 120′ are formed so as to partition areas where the phosphor layers 125 are disposed and to increase the areas. The phosphor layers 125 are disposed in different colors, so as to implement a full-color display. For example, when a color image is realized with the three primary colors of light, red, green, and blue phosphor layers 125 are alternately disposed within the grooves 120′. In each discharge space S′, red, green, and blue monochrome light is emitted according to the type of phosphor layers 125 and is combined, thus one color image is formed.

The first discharge electrode 135 and the second discharge electrode 145 together cause a display discharge within the discharge spaces S′. For example, AC voltages may be applied to the first and second discharge electrodes 135, 145 in order to cause a discharge. As a result, the discharge gas filled in the discharge spaces S′ is excited and ultraviolet rays are generated. The ultraviolet rays are changed into visible rays that a user can perceive through the phosphor layers 125, and the visible rays are transmitted through the front substrate 110 so that a predetermined image can be formed.

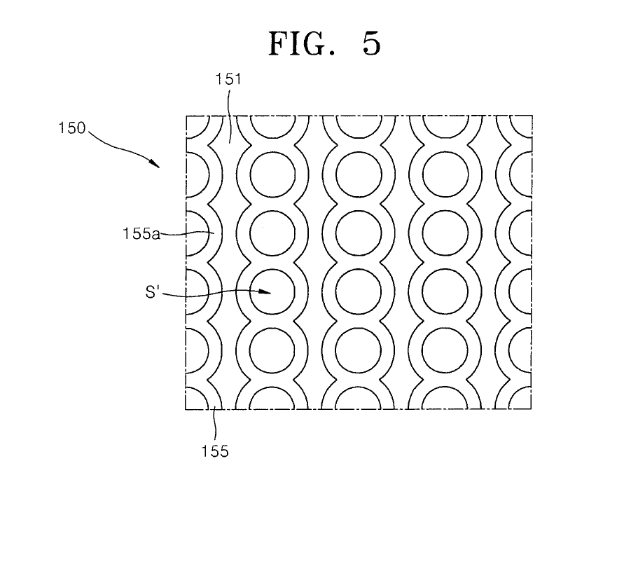

FIG. 5 illustrates a planar structure of an electrode sheet that can be used in the modified example of the PDP of FIG. 2. The electrode sheet 150 corresponds to a first electrode sheet 130 or a second electrode sheet 140 illustrated in FIG. 2. The electrode sheet 150 includes a plurality of discharge electrodes 155 arranged along one direction at predetermined intervals, and an insulating layer 151 forming a region between the discharge electrodes 155. Each discharge electrode 155 includes a plurality of discharge portions 155a surrounding the discharge spaces S′ and consecutively arranged in a lengthwise direction. That is, the structure of the electrode sheet is different from the above-described electrode structure in that the adjacent discharge portions 155a partially overlap one another and are directly connected to one another without an additional electrical connection portion.

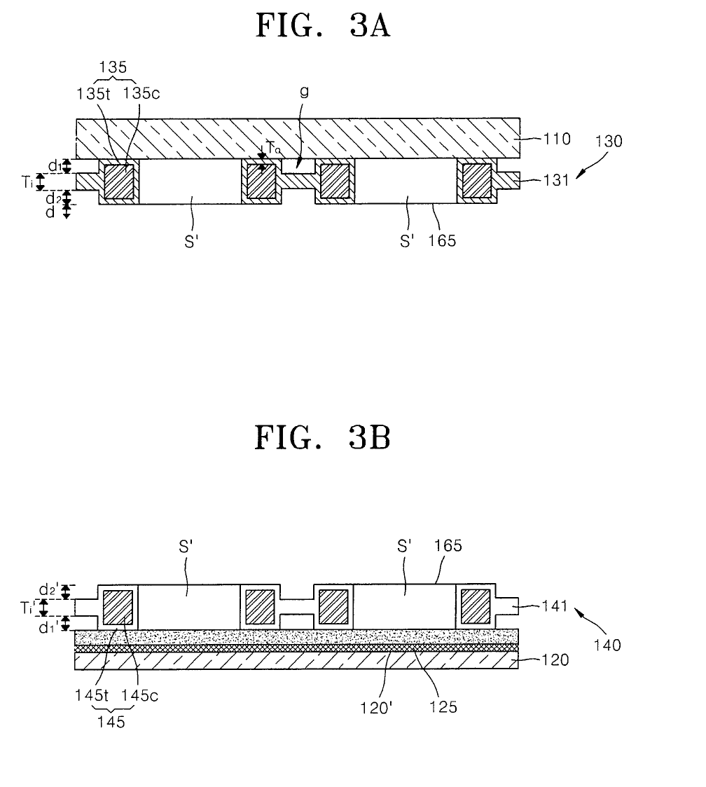

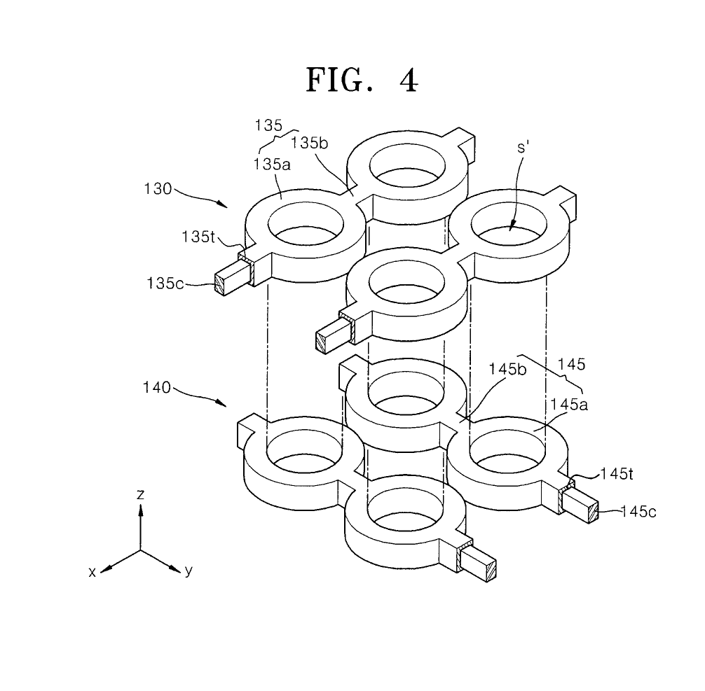

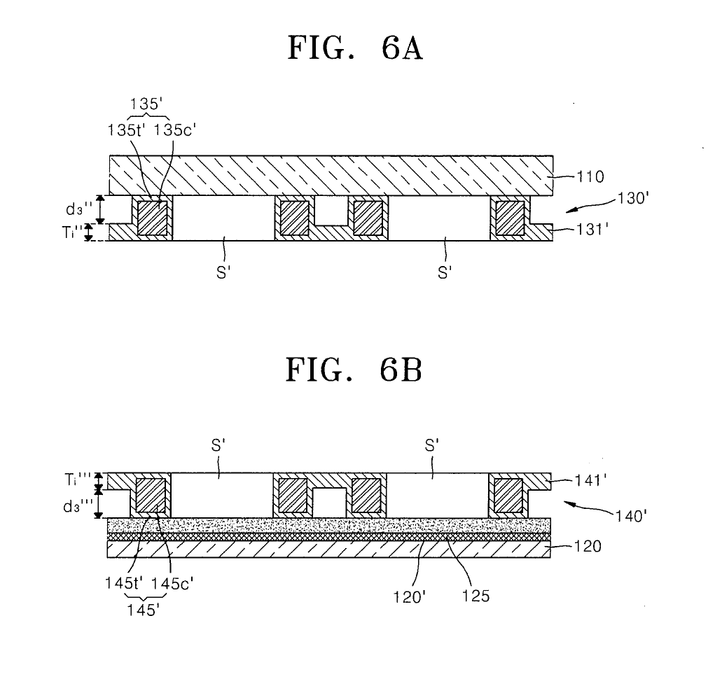

FIGS. 6A and 6B illustrate a partial cross-section structure of the modified example illustrated in FIG. 5. For reference, like elements performing the same functions as those of the above-described elements have like reference numerals. The PDP includes a front substrate 110 and a rear substrate 120 and a first electrode sheet 130′ and a second electrode sheet 140′, would be disposed between the substrates 110, 120 facing each other. Discharge electrodes 135′, 145′, which define the discharge spaces S′ and cause a display discharge within the discharge space, are formed in the first and second electrode sheets 130′, 140′, and insulating layers 131′, 141′ are formed between the discharge electrodes 135′, 145′. The insulating layers 131′, 141′ are formed to smaller thicknesses than those of the discharge electrodes 135′, 145′, so that the insulating layers 131′, 141′ can be oxidized throughout their entire thickness Tᵢ″, Tᵢ′″ In particular, in the present embodiment, the insulating layers 131′, 141′ form a step difference d₃″, d₃′″ with one side of the discharge electrodes 135′, 145′ in a thickness direction and constitute a flat side having the same height as that of the other side of the discharge electrodes 135′, 145′. The embodiment illustrated in FIG. 5 is different from the structure of the insulating layers 131, 141 forming the step differences d₁, d₂ with both sides of the discharge electrodes 135, 145 as shown in FIG. 4. In order to form the insulating layers 131, 141 to the same thickness Tᵢ″, Tᵢ′″, the step difference d₃″, d₃′″ of the present embodiment may be designed to be twice the step difference d₁ or d₂ illustrated in FIG. 3.

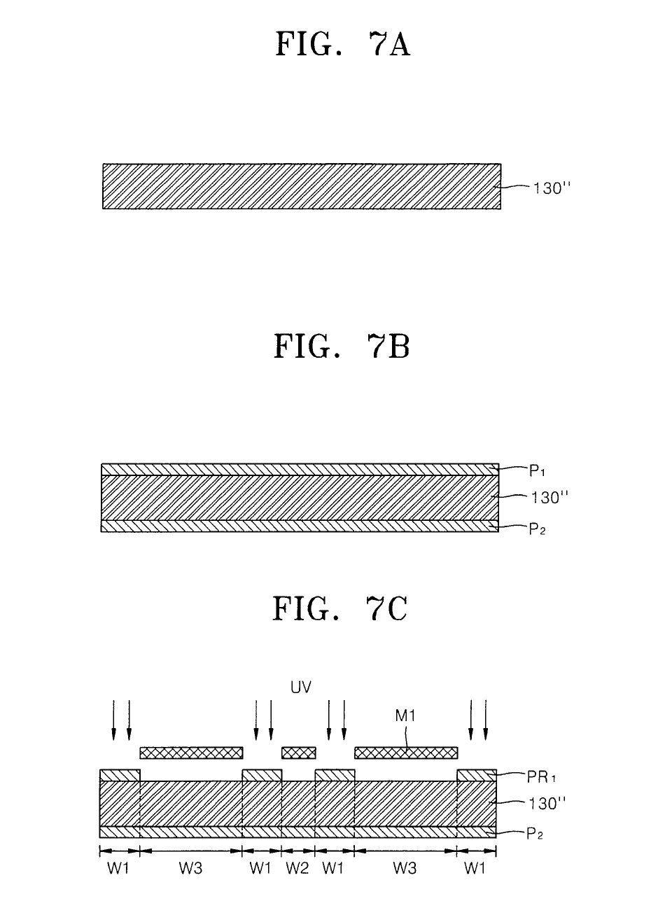

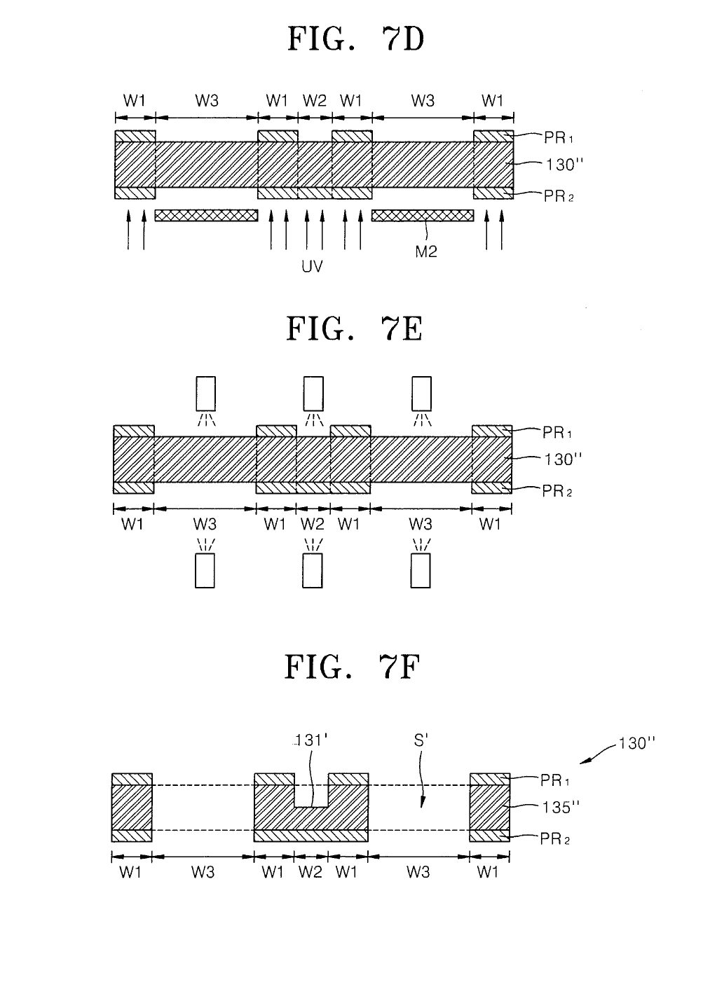

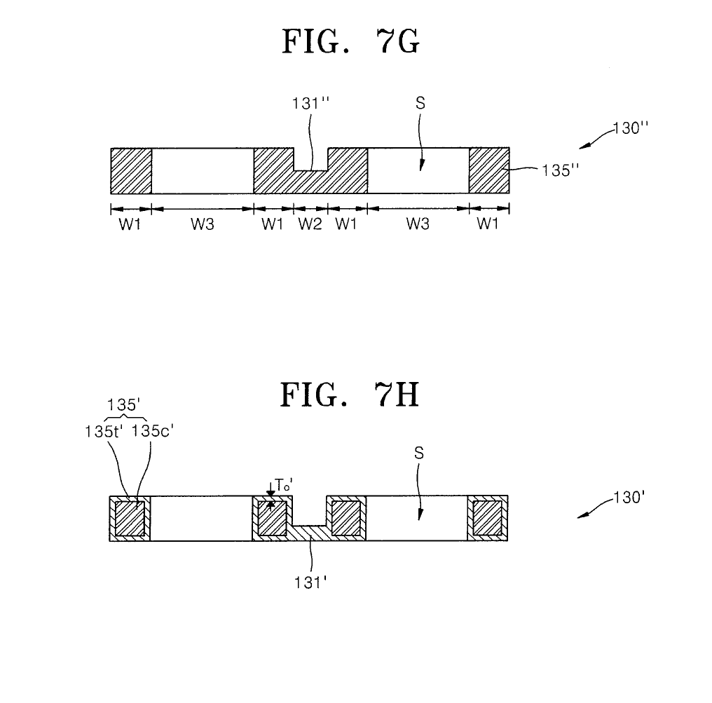

A method of manufacturing the electrode sheets illustrated in FIGS. 6A and 6B will now be described with reference to FIGS. 7A through 7H

As illustrated in FIG. 7A, a metallic sheet which is a raw material used in forming a first electrode sheet, is prepared. For example, an aluminium sheet 130″ having excellent conductivity and an excellent degree of oxidation due to a high chemical attraction with oxygen may be prepared. As illustrated in FIG. 7B, first and second photoresists P₁, P₂ are applied to upper and lower sides of the aluminium sheet 130″. The photoresists P₁, P₂ may be formed of photosensitive resin which is cured by a chemical reaction when it is exposed to radiation light such as UV.

As illustrated in FIG. 7C, by performing an exposure process of selectively radiating UV light on the upper first photoresist P₁ using an exposure mask M1 and a subsequent development process, a first PR mask PR₁ in which predetermined patterns are formed, is formed. The first PR mask PR₁ has patterns corresponding to a discharge electrode portion W1 and covers the corresponding portion W1. As illustrated in FIG. 7D, as in the above-described process, by performing an exposure process of selectively radiating UV light on the lower second photoresist P₂ using an exposure mask M2 and a subsequent development process, a second PR mask PR₂ in which predetermined patterns are formed, is formed. The second PR mask PR₂ has patterns corresponding to the discharge electrode portion W1 and a portion W2 between the discharge electrode portions W1 and covers the corresponding portions W1, W2. The first PR mask PR₁ and the second PR mask PR₂ respectively formed on upper and lower sides of the aluminium sheet 130″ may be aligned in a vertical direction. In a subsequent etching process, both sides of the aluminium sheet 130″ are etched using the first PR mask PR₁ and the second PR mask PR₂, and therefore, discharge spaces S′ and discharge electrodes 135″ are formed. This is because, when the first and second PR masks PR₁, PR₂ are incorrectly aligned and misalignment occurs, the discharge spaces S′ or the discharge electrodes 135″ cross one another in vertical and horizontal directions, and a display function of the PDP may be degraded.

As illustrated in FIGS. 7E and 7F, etching is performed on the upper side of the aluminium sheet 130″ by using the first PR mask PR₁ as an etch prevention layer. Discharge space portions W3 and the portion W2 between the discharge electrode portions W1 are selectively etched by upper side-etching. The portion W2 between the discharge electrode portions W1 is half-etched and forms a vertical step difference with the discharge electrode portions W1.

Further, as illustrated in FIGS. 7E and 7F, etching is performed on the lower side of the aluminium sheet 130″ by using the second PR mask PR₂ as an etch prevention layer. The discharge spaces portion W3 is selectively etched by lower side-etching. In this case, the lower side-etching is performed until the discharge space portions W3 are completely penetrated, and a discharge spaces S′ having a finished shape is obtained by full-etching in which etching is performed on both the upper and lower sides of the aluminium sheet 130″.

Successively, the first PR mask PR₁ and the second PR mask PR₂ are removed away, so that an electrode sheet 130″ as illustrated in FIG. 7G is obtained. Parts 135″, which are obtained after the etching process, become discharge electrodes 135″, and the remaining parts 131″ become insulation layers between the discharge electrodes 135′.

Then, as illustrated in FIG. 7H, an anodizing process of performing oxidization processing on the electrode sheet 130″ in order to form oxide films is performed. In the anodizing process, a DC voltage is applied, using the aluminum sheet (that is, the electrode sheet 130″) as an anode (+) and a Pt, Ni, or Carbon material acting as a catalyzer as a cathode (−) in an acidic electrolysis solution such as H₂SO₄, and oxidization proceeds toward from the surface of the aluminum sheet 130″ to its inside by means of an electrochemical reaction, so that oxide films 135t′ are formed. The thickness Tₒ′ of each oxide film 135t′ into which oxygen is permeated can be optimally controlled by adjusting the detailed process conditions (for example, the kind of electrolysis solution, the process time, the strength of the DC voltage, etc.) of the anodizing process. For example, the thickness Tₒ′ can be adjusted to be within 1-50 μm. The oxide films 135t′, which are formed on the surface of the electrode sheet 130″, are formed with alumina Al₂O₃, so that the oxidized portions of the electrode sheet becomes a ceramic material having an insulating property. Here, since parts between the discharge electrodes 135′ have a relatively thin thickness, the parts are completely oxidized and insulated to thus act as insulation layers 131′ for supporting and insulating the discharge electrodes 135′.

By repeating the processes described above, a plurality of electrode sheets having the same structure can be obtained. Then, as illustrated in FIG. 2, electrode sheets 130, 140 are disposed above and below so that the electrode sheets 130, 140 has a symmetry structure, and are coupled with an insulating adhesive agent in such a manner that they face each other. Even in the case when the electrode sheets 130, 140 are not coupled directly with the insulating adhesive agent, the stacked structure of the electrode sheets 130, 140 can be maintained by a cohesive force between a front substrate 110 and a rear substrate 120, which will be described below. That is, the insulating adhesive agent can be omitted.

Successively, a front substrate 110 and a rear substrate 120, which are to be disposed over and below the electrode sheets 130, 140, are prepared. The front substrate 110 and the rear substrate 120 may be glass substrates that contain glass as their main ingredient. Then, a plurality of grooves 120′ are formed with uniform intervals in the rear substrate 120. Phosphor layers 125 are disposed in the grooves 120′. Here, the grooves 120′ are formed with uniform intervals in correspondence to discharge spaces S′, wherein each discharge spaces is defined between electrode sheet structures. Finally, the front substrate 110 and the rear substrate 120 are arranged vertically to face each other so that the electrode sheets 130, 140 are located between the front substrate 110 and the rear substrate 120. Then, the front substrate 110 is coupled to the rear substrate 120, by a frit sealing agent applied along the edges of the front substrate 110 and the rear substrate 120.

When a PDP is manufactured, in order to decrease the thickness of a part W2 (see FIG. 7F) between the discharge electrodes 135″, a half-etching method of half-etching one surface of a layer and not etching the other surface of the layer can be used (see FIGS. 6A and 7F). In order to manufacture the electrode sheet 130 illustrated in FIG. 3A, a double-sided etching method of etching both sides of a layer can be used. Referring to FIGS. 3A and 7F, according to the double-sided etching method, both surfaces of the part W2 between discharge electrodes 135 are etched so that step heights d1, d2 are formed. In the double-sided etching method, deep etching is performed on discharge space parts W3 so that the discharge space parts W3 are completely removed, and shallow etching is performed on the part W2 between the discharge electrodes 135′ so that upper portions of the part W2 are removed and vertical step heights d1, d2 are formed between the part W2 and the discharge electrodes 135. In this manner, the electrode sheets 130 as illustrated in FIG. 3A can be obtained.

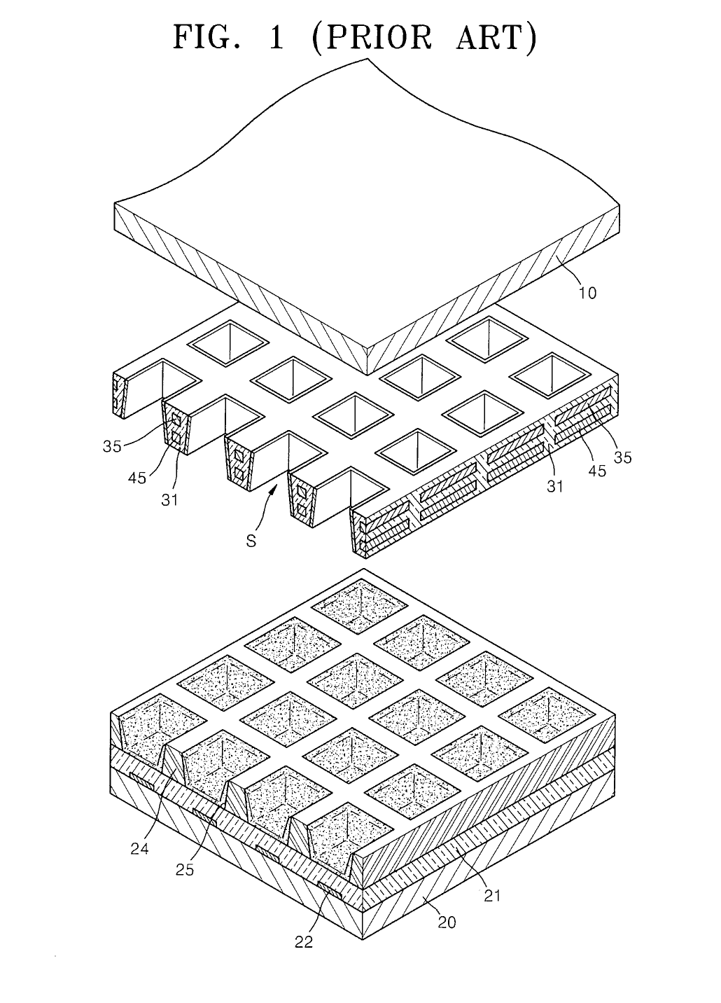

In a conventional 3-electrode surface discharge structure, since discharge electrodes are supported on a substrate, a dielectric layer can be easily formed to cover the discharge electrodes, by applying a dielectric paste to the substrate. However, as illustrated in FIG. 1, in a structure where discharge electrodes 35, 45 are disposed vertically and surround discharge spaces S, forming a dielectric layer 31 for covering the discharge electrodes 35, 45 in a well-known conventional manner increases the number of manufacturing processes or requires expensive equipment, resulting in an increase of manufacturing costs. In order to solve the problem, a new manufacturing method is needed.

According to an embodiment of the present invention, by oxidizing electrode sheets 130 having a discharge electrode pattern and forming oxide films 135t instead of a conventional dielectric layer on the surfaces of discharge electrodes, a simple manufacturing method suitable for automation can be implemented. Particularly, since the thickness of each discharge electrode 135 is different from the thickness of each insulation layer 131, by applying the same oxidization condition to all of the electrode sheets 130 without separate patterning for selective oxidization, the conductivity of the discharge electrodes 135 is maintained and the insulation layers 131 are insulated by the oxidization. Accordingly, the number of manufacturing processes can be minimized.

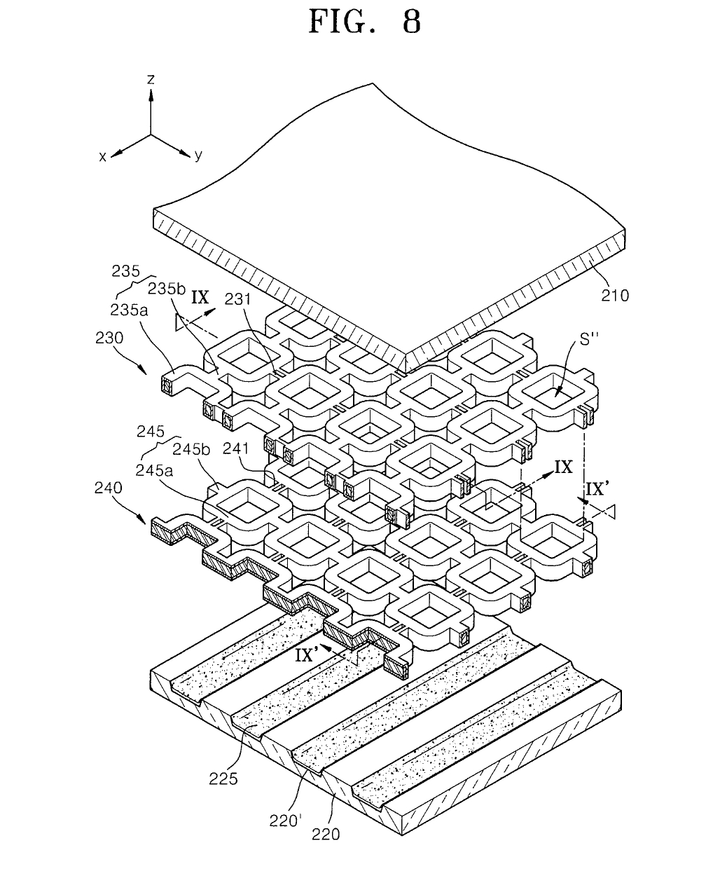

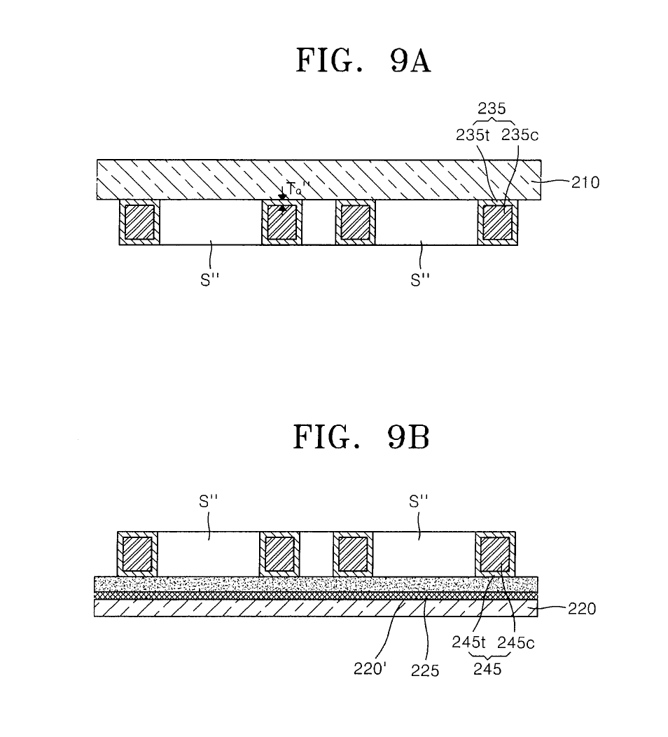

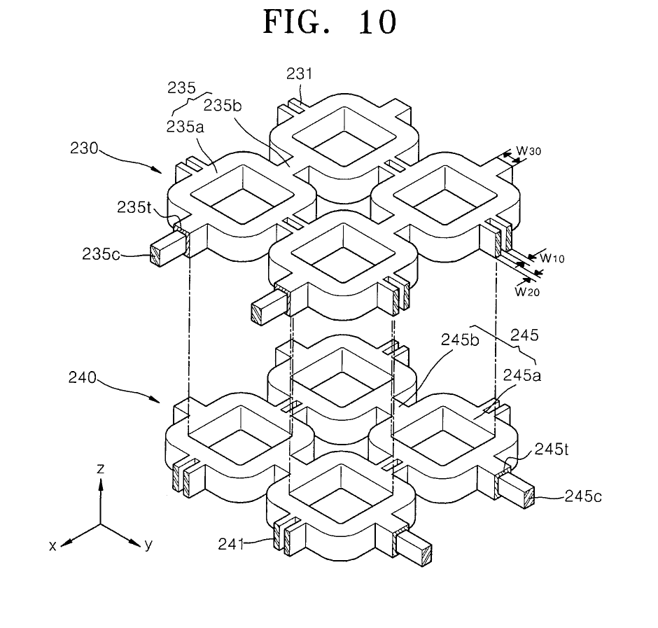

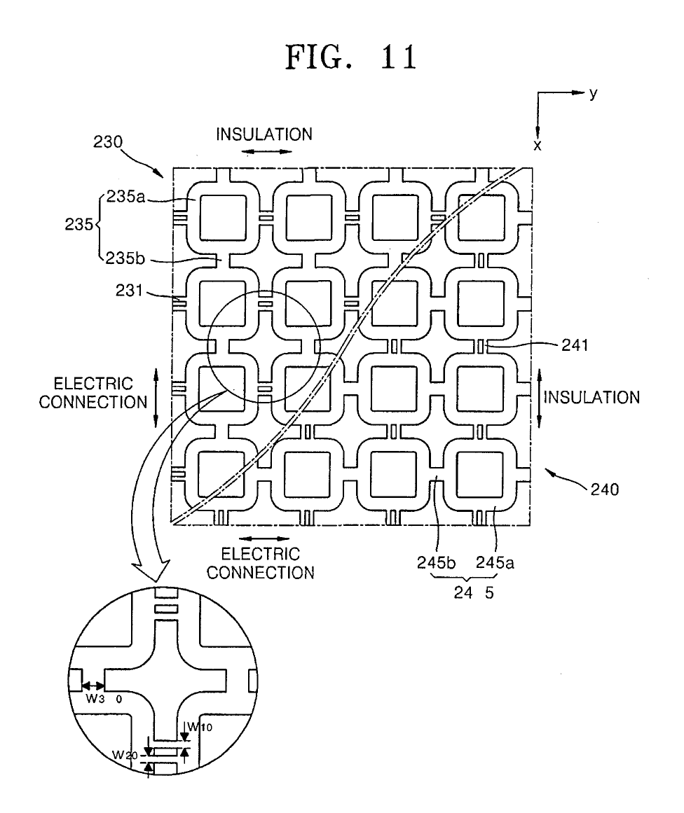

FIG. 8 is an exploded perspective view of a PDP according to another embodiment of the present invention. FIG. 9A is a partial cross-sectional view taken along a line IX-IX denoted in FIG. 8. FIG. 9B is a partial cross-sectional view taken along a line IX′-IX′ denoted in FIG. 8. Also, FIG. 10 is an enlarged perspective view of a part of electrode sheets illustrated in FIG. 8. FIG. 11 is a plan view of the electrode sheets of FIG. 10, wherein the upper left portion of the square diagram shows a plan view of electrode sheet 230 and the lower right portion of the square diagram shows a plan view the electrode sheet 240.

Referring to FIG. 8, the PDP includes a front substrate 210, a rear substrate 220 which faces the front substrate 210, and a first electrode sheet 230, and a second electrode sheet 240 which faces the first electrode sheet 230, wherein the first and second electrode sheets 230, 240 are located between the front and rear substrates 210, 220 and form discharge spaces S″. The respective first and second electrode sheets 230, 240, which have an integrated structure, are formed by forming discharge electrodes 235, 245 with a predetermined pattern in a raw material metal sheets, forming bridges 231, 241 for connecting the discharge electrodes 235, 245 with each other, and insulating the bridges 231, 241 through oxidization. Each metal sheet which is a raw material may be an aluminum sheet which has high electric conductivity and can be relatively easily insulated by undergoing a process of oxidization, taking into consideration power loss due to self-resistance of discharge electrodes.

In more detail, the first electrode sheet 230 includes a plurality of first discharge electrodes 235 that are extended in an x direction and surround discharge spaces S″ that are aligned in a line. The first discharge electrodes 235 include discharge portion 235a that surround the discharge spaces S″ and electrical connection portion 235b that electrically connect the discharge portion 235a with each other. The discharge portion 235a surround the discharge spaces S″ and define independent light-emitting areas. Also, the discharge portion 235a generate a display discharge in pairs together with different discharge portion 245a in the corresponding discharge spaces S″. The discharge portion 235a illustrated in the drawings have square link shapes. If the corners of the discharge portion 235a are angled, an electric field can become concentrated on the corner portions, and oxide films 235t covering the discharge portion 235a can be damaged. For this reason, in one exemplary embodiment the corner portions of the discharge portion 235a are rounded. The shape of each discharge portion 235a may be a polygon link shape, a circle ring shape, an oval ring shape, etc. However, the present invention is not limited to these. According to the shape of the corner portions of the discharge portion 235a, the discharge spaces S defined by the discharge portion 235a will have a corresponding shape.

The electrical connection portions 235b electrically connect the discharge portion 235a that are separated by predetermined intervals from each other, in an x direction, so as to allow the discharge portion 235a arranged in the x direction to receive the same driving signal, thereby forming a discharge electrode 235. In order to make the electrical connection portion 235b electrically conductive, the electrical connection portion 235b are formed with a sufficiently wide width W30. If the electrical connection portion 235b have a wide width W30, when some parts of the first electrode sheet 230 are insulated by anodizing, etc., the surfaces of the electrical connection portion 235b lose conductivity, but the internal core portions of the electrical connection portion 235b will still maintain conductivity as they are not oxidized. That is, considering the process conditions of anodizing, the width W30 of each electrical connection portion 235b is made wide enough such that the electrical connection portion 235b has a core part 235c into which no oxygen is penetrated along a width direction and in which conductivity is maintained until all processes are terminated. In this case, the core part 235c having conductivity would have a sufficient cross-sectional area, taking into consideration driving efficiency. After the oxidization process is completed, oxide films 235t are formed with a predetermined thickness Tₒ″ on the surfaces of the first discharge electrodes 235. The oxide films 235t formed on the surfaces of the first discharge electrodes 235 that surround the discharge spaces S″ (also, referred to as discharge cells S″) act as protection for the first discharge electrodes 235 from ion collision due to a discharge. The first discharge electrodes 235 and the second discharge electrodes 245 arranged vertically can be electrically insulated by the oxide films 235t.

Adjacent first discharge electrodes 235 are structurally supported by a bridge 231 therebetween. The bridge 231 connects the adjacent discharge electrodes 235 with each other, thereby preventing wavering or distortion of the first electrode sheet 230. The bridge 231 is extended in a direction intersecting the discharge electrodes 235 that are extended in the x direction. For example, the bridge 231 is extended in a y direction crossing the discharge electrodes 235. A plurality of bridges 231 can be formed in parallel at predetermined intervals, in order to act as supporting strength required for the first electrode sheet 230.

The bridges 231 are formed of an insulating oxide material in order to insulate the adjacent first discharge electrodes 235 and prevent the first discharge electrodes 235 through which different driving signals are transferred from being electrically disconnected from each other. As such, the discharge portion 235a that surround the discharge spaces S″ are electrically connected with each other in the x direction by the electrical connection portion 235b, and are electrically disconnected from each other in the y direction by the bridges 231. As described above, each bridge 231 can be formed between adjacent first discharge portion 235a. If the bridge 231 is used for insulation and support between the adjacent first discharge electrodes 235, the bridge 231 can be formed between the electrical connection portion 235b.

In an exemplary embodiment, the widths W10, W20 of the bridge 231 are narrow enough that oxidization proceeds toward the inside of the bridge 231 in the width direction and thus the entire bridge 231 is completely insulated, due to the fact that oxidation processing proceeds from a surface. As a result, under the same oxidization conditions, the electrical connection portion 235b would have core areas 235c where conductivity is maintained, while the bridges 231 would be completely insulated by the oxidization. Therefore, the width W30 of each conductive part and the widths W10, W20 of the bridge would satisfy the following relationships.

W30>W10

W30>W20

Also, since oxidation proceeds from an external surface exposed to an electrolysis solution, a substance having a wide surface area with respect to the same volume can be easily oxidized. Accordingly, the following relationship is satisfied between a surface area Sv3 per unit volume of each conductive part 235b and a surface area Sv1 per unit volume of each bridge 231.

Sv3>Sv1

In the embodiment illustrated in FIG. 10, since a pair of bridges 231 are formed in parallel while being separated from each other, the lateral portions of the bridges 231 can be oxidized through an opening portion between the bridges 231. That is, by forming a plurality of bridges 231 having a narrow width instead of forming a single bridge having a wide width, it is possible to enlarge the entire surface area of the bridges 231 and facilitate oxidization of the bridges 231. If the total width of the bridges 231 is equal to the width of a single bridge, a supporting strength of the electrode sheet 230 can be equally maintained in both the cases.

The second electrode sheet 240 arranged vertically with the first electrode sheet 230 basically has the same structure as the first electrode sheet 230. That is, a plurality of discharge spaces S″ are formed in the second electrode sheet 240, and a plurality of second discharge electrodes 245 are extended in a direction while surrounding the discharge spaces S″. The second discharge electrodes 245 can be extended in a direction (for example, in the y direction crossing the first discharge electrodes 235) intersecting the first discharge electrodes 235. The second discharge electrodes 245 include discharge portion 245a which partition the discharge spaces S″ and directly participate in a discharge, and electrical connection portion 245b which electrically connect the discharge portion 245a with each other in the y direction. Discharge spaces S″ in which a display discharge will occur can be selected by means of the first discharge electrodes 235 and the second discharge electrodes 245 which are arranged to cross with each other. The second discharge electrodes 245 are structurally supported by each other, by a plurality of bridges 241 formed therebetween, and are electrically disconnected from each other. The bridges 241 can be extended in the x direction between the discharge portion 245a. The discharge portion 245a which surround the discharge spaces S″ are electrically connected with each other in the y direction by the electrical connection portion 245b, and electrically disconnected from each other in the x direction by the bridges 241.

The front substrate 210 and the rear substrate 220 may be glass substrates formed of a glass material. Referring to FIG. 8, a plurality of grooves 220′ can be formed with predetermined intervals in the rear substrate 220, in correspondence to the discharge spaces S″. Phosphor layers 225 can be disposed in the grooves 220′. Although not illustrated in the drawings, the phosphor layers 225 can be disposed on the front substrate 210 as well as on the rear substrate 220. In order to form the phosphor layers 225 on the front substrate 210, a plurality of grooves can be formed on the front substrate 210, in order to define areas in which the phosphor layers 225 are formed. In this case, by forming phosphor layers 225 in correspondence to all discharge spaces S″, it is possible to prevent ultraviolet light generated by a discharge from escaping to the outside through the front substrate 210, thereby improving the ultraviolet-visible light conversion efficiency and driving efficiency of a PDP.

In FIG. 10, the first discharge electrodes 235 and the second discharge electrodes 245 are extended in such a manner that they cross each other. However, the first and second discharge electrodes 235, 245 can be extended in parallel. In an exemplary embodiment separate address electrodes (not shown) would be disposed on the front substrate 210 and the rear substrate 220 in such a manner that separate address electrodes are extended in a direction which intersects the direction of the first and second discharge electrodes 235, 245.

The PDP illustrated in FIG. 8 can be manufactured by processes similar to those illustrated in FIGS. 7A through 7H. In the processes illustrated in FIGS. 7A through 7H, half-etching is applied to form step heights with respect to insulation layers W2. However, in order to manufacture the PDP according to embodiments of the present invention, only double-sided etching is applied to form the same discharge electrode and the same bridge pattern with respect to both sides of an original substance.

Further, the number of electrode sheets 230, 240 which are disposed between the front substrate 210 and the rear substrate 220 and that partition the discharge spaces S″ is not limited to the embodiments described above. Also, the technical concept of the present invention can be applied in the same manner to structures including an arbitrary number of electrode sheets in order to ensure sufficient discharge spaces.

As described above, according to the present invention, by oxidizing metal sheets with discharge electrode patterns and forming oxide films instead of dielectric layers on the surfaces of discharge electrodes, a additional process for forming a dielectric layer is not needed. Particularly, by providing a new display panel having an electrode structure surrounding discharge spaces and is suitable for mass-production, it is possible to remove limitations in manufacturing of conventional display panels and facilitate the use of highly-effective display panels.

Also, by differentiating electrode parts requiring conductivity from insulation parts requiring insulation in terms of thickness, width, etc. so that the electrode parts maintain conductivity and the insulation parts are insulated when the same oxidization condition is applied to an entire metal sheet area without performing separate patterning for selective oxidization, it is possible to minimize the number of manufacturing processes.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a front substrate and a rear substrate spaced apart from each other; and
a plurality of electrode sheets stacked between the front substrate and the rear substrate, and having apertures for forming a plurality of discharge spaces,
wherein the electrode sheets include:
a plurality of metal discharge electrodes extending so as to surround at least a part of each of the discharge spaces arranged in a line, the metal discharge electrodes being separated from each other; and
insulation members:
between the metal discharge electrodes,
of an oxide material of a same metal as the metal discharge electrodes, and
insulating the metal discharge electrodes.

2. The plasma display panel of claim 1, wherein the metal discharge electrodes are conductive aluminum and the insulation members are insulating alumina.

3. The plasma display panel of claim 1, further comprising an oxide film on outer surfaces of the metal discharge electrodes.

4. A plasma display panel comprising:
a front substrate and a rear substrate spaced apart from each other; and
a first electrode sheet and a second electrode sheet stacked between the front substrate and the rear substrate, the first electrode sheet and the second electrode sheet each having apertures for forming a plurality of discharge spaces,
wherein the first electrode sheet includes:
a plurality of first metal discharge electrodes extending so as to surround at least a part of each of the discharge spaces arranged in a first direction, the first metal discharge electrodes being separated from each other; and
a first electrode sheet insulation layer:
between the first metal discharge electrodes,
having a first electrode sheet insulation layer step,
of an oxide material of a same metal as the first metal discharge electrodes, and
insulating the first metal discharge electrodes, and
wherein the second electrode sheet includes:
a plurality of second metal discharge electrodes extending and surrounding at least a part of each of the discharge spaces arranged in a second direction, the second metal discharge electrodes being separated from each other; and
a second electrode sheet insulation layer:
between the second metal discharge electrodes,
having a second electrode sheet insulation layer step,
of an oxide material of a same metal as the second metal discharge electrodes, and
insulating the second metal discharge electrodes.

5. The plasma display panel of claim 4, wherein the first metal discharge electrodes and the second metal discharge electrodes are conductive aluminum, and the first electrode sheet insulation layer and the second electrode sheet insulation layer are insulating alumina.

6. The plasma display panel of claim 4, further comprising an insulating oxide film on surfaces of the first metal discharge electrodes and on surfaces of the second metal discharge electrodes.

7. The plasma display panel of claim 4, wherein the first metal discharge electrodes and the second metal discharge electrodes further comprise:
discharge portions surrounding the discharge spaces and directly generating a discharge, and
electrical connection portions electrically connecting the discharge portions.

8. The plasma display panel of claim 4, wherein the first metal discharge electrodes and the second metal discharge electrodes extend crossing each other.

9. The plasma display panel of claim 4, wherein the first electrode sheet insulation layer has a thickness smaller than a thickness of the first metal discharge electrodes and the second electrode sheet insulation layer has a thickness smaller than a thickness of the second metal discharge electrodes.

10. The plasma display panel of claim 4, wherein:
one side of the first electrode sheet insulation layer has a step with adjacent first metal discharge electrodes,
one side of the second electrode sheet insulation layer has a step with adjacent second metal discharge electrodes,
an other side of the first electrode sheet insulation layer forms a flat surface with the first metal discharge electrodes, and
an other side of the second electrode sheet forms a flat surface with the second metal discharge electrodes.

11. The plasma display panel of claim 4, wherein both upper and lower sides of the first electrode sheet insulation layer has a step with adjacent first metal discharge electrodes, and both upper and lower sides of the second electrode sheet insulation layer has a step with adjacent second metal discharge electrodes.

12. The plasma display panel of claim 4, wherein the first electrode sheet insulation layer is on the first electrode sheet where the first metal discharge electrodes are absent, and the second electrode sheet insulation layer is on the second electrode sheet where the second metal discharge electrodes are absent.

13. The plasma display panel of claim 4, further comprising:
a plurality of rear substrate grooves in the rear substrate associated with the discharge spaces, and
rear substrate phosphor layers in the rear substrate grooves.

14. The plasma display panel of claim 13, further comprising:
a plurality of front substrate grooves in the front substrate associated with the discharge spaces, and
front substrate phosphor layers in the front substrate grooves.

15. The plasma display panel of claim 4, further comprising an insulating adhesive agent is between and combining the first electrode sheet and the second electrode sheet.

16. A plasma display panel comprising:
a front substrate and a rear substrate spaced apart from each other; and
a first electrode sheet and a second electrode sheet stacked between the front substrate and the rear substrate, and having apertures for forming a plurality of discharge spaces,
wherein the first electrode sheet includes:
a plurality of first metal discharge electrodes having discharge portions surrounding the discharge spaces arranged in a line and first electrode sheet electrical connection portions electrically connecting the discharge portions; and
one or more first electrode sheet bridges adjacent to the first metal discharge electrodes, extending so as to have a narrower width than the first electrode sheet electrical connection portions and insulating the first metal discharge electrodes, and
wherein the second electrode sheet includes:
a plurality of second metal discharge electrodes having discharge portions surrounding the discharge spaces arranged in a line and second electrode sheet electrical connection portions electrically connecting the discharge portions; and
one or more second electrode sheet bridges adjacent to the second metal discharge electrodes, extending so as to have a narrower width than the second electrode sheet electrical connection portions and insulating the second metal discharge electrodes.

17. The plasma display panel of claim 16, wherein the one or more first electrode sheet bridges are an oxide material of a metal of the first metal discharge electrodes and the one or more second electrode sheet bridges are an oxide material of a metal of the second metal discharge electrodes.

18. The plasma display panel of claim 17, wherein:
the first metal discharge electrodes and the second metal discharge electrodes are conductive aluminum, and
the one or more first electrode sheet bridges and the one or more second electrode sheet bridges are insulating alumina.

19. The plasma display panel of claim 16, further comprising an insulating oxide film on surfaces of the first metal discharge electrodes and on surfaces of the second metal discharge electrodes.

20. The plasma display panel of claim 16, wherein the first metal discharge electrodes and the second metal discharge electrodes extend crossing each other.

21. The plasma display panel of claim 16, wherein the one or more first electrode sheet bridges extend in a direction perpendicular to the first metal discharge electrodes and the one or more second electrode sheet bridges extend in a direction perpendicular to second metal discharge electrodes.

22. The plasma display panel of claim 16, wherein the one or more first electrode sheet bridges are between the discharge portions of adjacent first metal discharge electrodes and the one or more second electrode sheet bridges are between the discharge portions of adjacent second metal discharge electrodes.

23. The plasma display panel of claim 19, further comprising, when the one or more first electrode sheet bridges are between the first metal discharge electrodes and the one or more second electrode sheet bridges are between the second metal discharge electrodes, two or more adjacent bridges extending parallel to each other as a unit.

24. The plasma display panel of claim 16, wherein:
the discharge portions of the first electrode sheet are electrically connected in a first direction in which the first electrode sheet electrical connection portions extend and are insulated in a second direction in which the first electrode sheet bridges extend; and
the discharge portions of the second electrode sheet are electrically connected in a second direction in which the second electrode sheet electrical connection portions extend and are insulated in a first direction in which the second electrode sheet bridges extend.

25. The plasma display panel of claim 16, further comprising:
a plurality of rear substrate grooves in the rear substrate associated with the discharge spaces, and
rear substrate phosphor layers in the rear substrate grooves.

26. The plasma display panel of claim 25, further comprising:
a plurality of front substrate grooves in the front substrate associated with the discharge spaces, and
front substrate phosphor layers in the front substrate grooves.

27. The plasma display panel of claim 16, further comprising an insulating adhesive agent between and combining the first electrode sheet and the second electrode sheet.

28. The plasma display panel of claim 16, wherein a surface area of each bridge per unit volume is greater than a surface area of each discharge electrode connection portion per unit volume.
